(19) United States
(12) Patent Application Publication
(10) Pub. No.: US 2011/0213065 A1
(43) Pub. Date: Sep. 1, 2011

(54) SYNTHETIC INORGANIC FLAME RETARDANTS, METHODS FOR THEIR PREPARATION, AND THEIR USE AS FLAME RETARDANTS

(75) Inventors: Monika Giesselbach, Koeln (DE); Wolfgang Hoepfl, Kandern (DE); Rene G.E. Herbiet, Eupen (BE); Guenther Peter Heines, Erkelenz (DE)

(73) Assignee: ALBEMARLE CORPORATION, Baton Rouge, LA (US)

(21) Appl. No.: 13/126,010

(22) PCT Filed: Nov. 13, 2009
(86) PCT No.: PCT/US09/64305

§ 371 Date: Apr. 26, 2011

Related U.S. Application Data
(60) Provisional application No. 61/117,191, filed on Nov. 23, 2008.

(51) Int. Cl. C08K 3/34; C09K 21/02; C08K 3/32; C08K 3/22; C09K 21/04

(52) U.S. Cl. 524/417; 252/609; 524/450; 524/436

(57) ABSTRACT

Quite unexpectedly, by suitably modifying the crystal structure of hydrogarnets of the general formula M^{II}₃Mr^{I-III}₂(OH)₁₂ (where M^{II} denotes divalent metal ions, especially alkaline earth metal ions, of Group IIA of the periodic table and M^{III} denotes trivalent metal ions of Group IIIA of the periodic table, especially aluminum) with suitable amounts of incorporated silicate and/or phosphate, flame retardants having both a higher flame retardant efficiency than such traditional mineral flame retardants as ATH and MDH, and a higher thermal stability than ATH can be produced. It has also been found that synthetic hydrogarnets of the general formula M^{II}₃Mr^{III}₂(OH)₁₂(where M^{II} and M^{III} are as defined above) having cubic crystal and these synthetic hydrogarnets also show high flame retardant efficiency.

### BACKGROUND

Commonly used mineral flame retardants for polymers such as aluminum trihydroxide (ATH) and magnesium hydroxide (MDH) have a limited efficiency. High loadings are necessary to pass relevant flame tests. In some cases, even when used at highest loadings, certain flame tests are too demanding or the mechanical, rheological or electrical properties of the final product are destroyed. Furthermore, ATH starts to decompose at about 200° C., which limits the application to polymers that are processed at similar or lower temperatures.

It would be of considerable advantage to the art if a way could be found of providing new inorganic flame retardants having a higher flame retardant efficiency that would also allow for lower filler loadings than traditional products such as ATH and MDH and, preferably, having a sufficiently higher thermal stability than ATH so that such new flame retardants could be effectively used in polymeric materials requiring use of processing temperatures above 200° C.

This invention is deemed to fulfill the foregoing advantage on an economically attractive basis.

### SUMMARY OF THE INVENTION

Pursuant to this invention, it was surprisingly found that the addition of alkali hydroxides to the synthesis of hydrogarnets of the general formula M^{II}₃M^{III}₂(OH)₁₂ (where M^{II} denotes divalent metal ions, especially alkaline earth metal ions, of Group IIA of the periodic table and M^{III} denotes trivalent metal ions of Group IIIA of the periodic table, especially aluminum) modifies the crystal shape from irregular, nearly spherical crystals to clearly defined cubes. These synthetic hydrogarnet compounds can be used as flame retardant materials having both a higher flame retardant efficiency than such traditional mineral flame retardants as ATH and MDH, and a higher thermal stability than ATH.

It was further found, quite unexpectedly, by suitably modifying the crystal structure of hydrogarnets of the general formula M^{II}₃M^{III}₂(OH)₁₂ (where M^{II} and M^{III} are as defined above) with suitable amounts of incorporated silicate and/or phosphate, flame retardant materials having both a higher flame retardant efficiency than such traditional mineral flame retardants as ATH and MDH, and a higher thermal stability than the hydrogarnets synthesized in the presence of alkali hydroxides can be produced. By addition of silicate or phosphate ions in the crystal structure, flame retardant compounds of the empirical formula M^{II}₃M^{III}₂(OH)₁₂₋₄ₓ(SiO₄)ₓ in case of only silicate incorporation, M^{II}₃M^{III}₂(OH)_{12-5y}(PO₄)_{y} in case of only phosphate incorporation, or M^{II}₃M^{III}₂(OH)_{12-5y-4y}(PO₄)_{y}(SiO₄)ₓ in case of incorporation of both silicate and phosphate, are obtained.

The crystal structures of the silicon-modified and/or phosphorus-modified compositions are related to hydrogarnet (i.e., M^{II}₃M^{III}₂(OH)₁₂) and garnet (i.e., M^{II}₃M^{III}₂(SiO₄)₃), but the flame retardants of this invention differ in composition and properties from both garnet and hydrogarnet. The silicon-modified and/or phosphorus-modified compositions have crystal shapes that are generally octahedral.

The crystal shape of the hydrogarnet compounds of the invention that are not silicon-modified and/or phosphorus-modified is generally cubic. Hydrogarnet crystals produced by U.S. Pat. No. 3,912,671 were reported to spherical in shape; following the procedures disclosed therein yielded irregular isometric polyhedra.

The structural and compositional changes induced in this invention result in unexpected flame retardant benefits in performance. For example, as will be seen from Tables 1-3 hereinafter, the compositions of this invention have been found to have greater thermal stability than ordinary hydrogarnet.

Thus, this invention provides, among other things, a flame retardant comprised of synthetic hydrogarnet optionally modified by inclusion of silicate and/or phosphate ions in its crystal structure. Also provided by this invention is a flame retardant as just described further characterized in that the crystal structure of the flame retardant is related to hydrogarnet, i.e., M^{II}₃M^{III}₂(OH)₁₂. Such synthetic flame retardants can be characterized by providing enhanced heat release characteristics when incorporated in suitable concentration in ethylene-vinyl acetate test pieces which are subjected to combustion in a cone calorimeter. For example, time to reach a second heat release peak, if a second heat release peak is even reached, is longer and the heat release of the second maximum (if present) is lower. The absence of a second peak or its lower maximum value is a consequence of a stronger char formation, preventing burnable gases to enter the gas phase and to feed the flame.

In preferred embodiments this invention provides a synthetic inorganic modified hydrogarnet flame retardant characterized by (i) having the empirical formula M^{II}₃M^{III}₂O_{y}(OH)_{12-5y-4x}(PO₄)_{y}(SiO₄)ₓ wherein M^{II} is one or a mixture of more than one alkaline earth metal, preferably Ca; and x and y are numbers in the range of 0 to about 1.5, with x+y in the range of 0 to about 1.5, preferably in the range of about 0.05 to about 1.5; a more preferred range is about 0.1 to about 1.5; even more preferred is about 0.05 to about 1.2; and (ii) having the following properties:
a) a median particle size, d₅₀, in the range of about 0.5 to about 10 μm as determined by laser diffraction;
b) a surface area in the range of about 0.5 to about 30 m²/g as determined by BET, preferably between about 1 to about 30 m²/g, preferably between about 0.5 to about 15 and between about 1 to about 15 m²/g, even more preferably between about 1 to about 10 or between about 2 and about 10 m²/g; and
c) a TGA temperature for a 2% water loss of >230° C., preferably >240° C., more preferably >250° C. at a heating rate of 1° C. per minute and after predrying at 105° C. during a period of 4 hours.

Still more preferred are synthetic inorganic flame retardants as above that are further characterized by having a surface moisture content of <0.7 wt %, preferably <0.5 wt %, as determined by infrared moisture balance at 105° C., and a sodium oxide content of <0.5 wt % as determined by flame photometry.

Also provided by this invention is process technology for producing synthetic flame retardants such as are described above. For example, this invention provides a process of preparing a synthetic inorganic hydrogarnet that is optionally modified with suitable amounts of silicate and/or phosphate, which process comprises:
agitating a mixture formed from
   (1) a Group IIIA metal source (especially an aluminum source),
   (2) a Group IIA metal source (especially an alkaline earth metal source),
   (3) optionally a source of silicon (especially an aqueous silicate solution, as for example, (i) one or more of the solutions of, e.g., NaSiO₃ or Na₂Si₃O₇ such as are commercially-available as “water glass” and/or (ii) amorphous or crystalline silicon dioxide in powder form), and/or
   (4) optionally a source of phosphorus (especially an aqueous phosphate solution, e.g., phosphoric acid, alkali or ammonium phosphate salts such as Na₃PO₄, Na₂HPO₄, NaH₂PO₄, alkali or ammonium diphosphate salts such as Na₄P₂O₇, and/or alkali or ammonium polyphosphate salts),
   wherein said (1), (2), (3), and/or (4), independently, and/or their respective hydrates are in solid form or in aqueous solution, and
   (5) an alkali metal hydroxide, and heating said agitated mixture at a temperature in the range of about 50 to about 100° C.;
optionally cooling the reaction product or allowing the reaction product to cool; and recovering the resultant product;
   said process being further characterized in that the proportions of the Group IIIA metal source and the Group IIA metal source used in forming the mixture are in a molar ratio of Group IIA metal:Group IIIA metal in the range of about 1:1 to about 2:1. When present, the source of silicon used in forming the mixture provides silicate in amounts in the range of about 0.05 to about 1.5 moles of silicate per mole of modified synthetic inorganic hydrogarnet prepared, and/or when present, the source of phosphorus used in forming the mixture provides phosphate in amounts in the range of about 0.05 to about 1.5 moles of phosphate per mole of modified synthetic inorganic hydrogarnet prepared. Preferred proportions of the source of silicon used in forming the mixture and/or the source of phosphorus used in forming the mixture provide silicate and/or phosphate in amounts in the range of about 0.1 to about 1.5 moles, more preferably in the range of about 0.05 to about 1.2 moles, of silicate and/or phosphate per mole of modified synthetic inorganic hydrogarnet prepared. In general, each atom of silicon from the silicon source forms one silicate ion in the modified synthetic inorganic hydrogarnet, and each atom of phosphorus from the phosphorus source forms one phosphate ion in the modified synthetic inorganic hydrogarnet.

It is to be noted that even though many of the reactants that can be used in the process have only low solubility in water and that, even under the reaction conditions used in the process only a small fraction of one or more reactants may be in solution, the reaction takes place via dissolved ions. Accordingly, even though at any given moment of time only a small amount of reactant may be dissolved in the water, as such ions are consumed in the reaction, previously undissolved amounts of such reactant go into solution in order to provide the necessary ions for the reaction to continue. Thus, the reaction can proceed very well with a compound not generally described as water-soluble, such as ATH or Al₂O₃.

A preferred process of this invention relates to the production of a synthetic flame retardant, which is modified by the incorporation therein of suitable amounts of silicate and/or phosphate. This process comprises:
agitating a mixture formed from a aluminum source, a calcium source, water, a source of silicon and/or phosphorus, and an alkali metal hydroxide, and heating said agitated mixture at a temperature in the range of about 50 to 100° C., the aluminum source being (i) aluminum hydroxide, boehmite, pseudo boehmite, aluminum oxide, or mixtures of any two or more of the foregoing, and (ii) in powder form, the calcium source being (i) an inorganic salt, hydroxide, or oxide of calcium, including hydrates thereof, and (ii) in powder form;
optionally cooling the reaction product or allowing the reaction product to cool; and
recovering the resultant product;
   said process being further characterized in that the proportions of aluminum source and calcium source used in forming the mixture provide a molar ratio of Ca:Al in the range of about 1:1 to about 2:1, and the source of silicon used in forming the mixture provides silicate in amounts in the range of about 0.05 to about 1.5 moles, preferably in the range of about 0.1 to about 1.5 moles, more preferably in the range of about 0.05 to about 1.2 moles, of silicate per mole of synthetic flame retardant produced, and/or the source of phosphorus used in forming the mixture provides phosphate in amounts in the range of about 0.05 to about 1.5 moles, preferably in the range of about 0.1 to about 1.5 moles, more preferably about 0.05 to about 1.2 moles, of phosphate per mole of synthetic flame retardant produced.

The above and other features, embodiments, and advantages of this invention will become still further apparent from the ensuing description, accompanying drawings, and appended claims.

### BRIEF DESCRIPTION OF THE DRAWINGS

FIG. 1 shows cone calorimeter heat release rate curves for Example 6 (inventive) and Example 9 (comparative).

FIG. 2 shows cone calorimeter heat release rate curves for Examples 7 (inventive) and Example 9 (comparative).

FIG. 3 shows cone calorimeter heat release rate curves for Example 8 (inventive) and Example 9 (comparative).

FIG. 4 shows cone calorimeter heat release rate curves for Example 10 (inventive) and Example 12 (comparative).

FIG. 5 shows cone calorimeter heat release rate curves for Example 11 (inventive) and Example 12 (comparative).

FIG. 6 shows an SEM micrograph of a modified hydrogarnet made as in Example 1.

FIG. 7 shows an SEM micrograph of a hydrogarnet made as in Example 5.

FIG. 8 shows an SEM micrograph of a hydrogarnet made as in U.S. Pat. No. 3,912,671.

### FURTHER DETAILED DESCRIPTION OF THIS INVENTION

Without wishing to be bound by theory, the structures of the compounds of the invention in which silicate and/or phosphate ions are present can be thought of as having the same arrangement of atoms as hydrogarnet, with some groupings of four hydroxide ions exchanged for a silicate or phosphate ion; in the crystal structures, the four oxygen atoms of the silicate or phosphate ion are believed to be in the same place as were the oxygen atoms of the four hydroxide ions.

As noted above, novel flame retardants of this invention can be represented by the following general formula (1):

M^{II}₃M^{III}₂O_{y}(OH)_{12-5y-4x}(PO₄)_{y}(SiO₄)ₓ (1)

where M^{II} is a Group IIA metal atom, typically Ca, Sr, or Ba, or a mixture of at least two of these, or a mixture of any one or more of these with a minor proportion (i.e., less than about 50% by weight) of Mg; M^{III} is a Group IIIA metal atom, especially aluminum, but which may be in admixture with small amounts (e.g., less than about 20% by weight) of B, Ga, In, or Tl, or a mixture of any two or more of these; and where x and y are numbers in the range of 0 to about 1.5, with x+y in the range of 0 to about 1.5, preferably in the range of about 0.05 to about 1.5, more preferably in the range of about 0.1 to about 1.5, even more preferred is about 0.05 to about 1.2. The presence of trace amounts of other metal atoms that do not adversely affect the flame retardant and thermal stability properties of the flame retardant can be present. When no silicon or phosphorus source is used in synthesizing the product, the product can be represented by the formula M^{II}₃M^{III}₂(OH)₁₂, where M^{II} and M^{III} are as in formula (1) above. When no phosphorus source is used in synthesizing the product, the product can be represented by the following general empirical formula:

M^{II}₃M^{III}₂(OH)₁₂₋₄ₓ(SiO₄)ₓ (1A)

wherein M^{II} and M^{III} are as in formula (1) above, and x is in the range of about 0.05 to about 1.5, preferably in the range of about 0.1 to about 1.5, more preferably in the range of about 0.05 to about 1.2. When no silicon source is used in synthesizing the product, the product can be represented by the following general empirical formula:

M^{II}₃M^{III}₂O_{y}(OH)_{12-5y}(PO₄)_{y} (1B)

wherein M^{II} and M^{III} are as in formula (1) above, and y is in the range of about 0.05 to about 1.5, preferably in the range of about 0.1 to about 1.5, more preferably in the range of about 0.05 to about 1.2.

Preferred flame retardants of this invention can be represented by the following general empirical formula (2):

M^{II}₃M^{III}₂O_{y}(OH)_{12-5y-4x}(PO₄)_{y}(SiO₄)ₓ (2)

where M^{II} is a Group IIA metal atom, typically Ca, Sr, or Ba, or a mixture of at least two of these, or a mixture of any one or more of these with a minor proportion (i.e., less than about 50% by weight) of Mg; and where x and y are numbers in the range of 0 to about 1.5, with x+y in the range of about 0 to about 1.5, preferably in the range of about 0.05 to about 1.5; more preferably in the range of about 0.1 to about 1.5, even more preferably in the range of about 0.05 to about 1.2. Here again, the presence of trace amounts of other metal atoms that do not adversely affect the flame retardant and thermal stability properties of the flame retardant can be present. When no silicon or phosphorus source is used in synthesizing the product, the product can be represented by the formula M^{II}₃Al₂(OH)₁₂, where M^{II} is as in formula (2) above. When no phosphorus source is used in synthesizing the product, the product can be represented by the following general empirical formula:

M^{II}₃Al₂(OH)₁₂₋₄ₓ(SiO₄)ₓ (2A)

wherein M^{II} is as in formula (2) above, and x is in the range of about 0.05 to about 1.5, preferably in the range of about 0.1 to about 1.5, more preferably in the range of about 0.05 to about 1.2. When no silicon source is used in synthesizing the product, the product can be represented by the following general empirical formula:

M^{II}₃Al₂O_{y}(OH)_{12-5y}(PO₄)_{y} (2B)

wherein M^{II} is as in formula (2) above, and y is in the range of about 0.05 to about 1.5, preferably in the range of about 0.1 to about 1.5, more preferably in the range of about 0.05 to about 1.2.

Especially preferred flame retardants of this invention can be represented by the following general empirical formula (3):

Ca₃Al₂O_{y}(OH)_{12-5y-4x}(PO₄)_{y}(SiO4)ₓ (3)

where x and y are numbers in the range of 0 to about 1.5, with x+y in the range of about 0 to about 1.5, preferably in the range of about 0.05 to about 1.5; more preferred ranges are about 0.1 to about 1.5 and about 0.05 to about 1.2. As above, the presence of trace amounts of other metal atoms that do not adversely affect the flame retardant and thermal stability properties of the flame retardant can be present. When no silicon or phosphorus source is used in synthesizing the product, the product can be represented by the formula Ca₃Al₂(OH)₁₂. When no phosphorus source is used in synthesizing the product, the product can be represented by the following general empirical formula:

Ca₃Al₂(OH)₁₂₋₄ₓ(SiO₄)ₓ (3A)

wherein x is in the range of about 0.05 to about 1.5, preferably in the range of about 0.1 to about 1.5, more preferably in the range of about 0.05 to about 1.2. When no silicon source is used in synthesizing the product, the product can be represented by the following general empirical formula:

Ca₃Al₂O_{y}(OH)_{12-5y}(PO₄)_{y} (3B)

wherein y is in the range of about 0.05 to about 1.5, preferably in the range of about 0.1 to about 1.5, more preferably in the range of about 0.05 to about 1.2.

The flame retardants of this invention (flame retardants of formulas (1), (1A), (1B), (2), (2A), (2B), (3), (3A), or (3B) above) are flame retardants of increased effectiveness and are further characterized by having enhanced thermal stability. It is also believed that by virtue of the inclusion of silicate and/or phosphate in the crystal structure, the resultant crystal growth characteristics of the flame retardants of this invention can be influenced in a favorable manner. This in turn could have a beneficial influence on various characteristics of the flame retardants, such as purity. In this connection, in particularly preferred flame retardants of this invention (flame retardants of formulas (1), (1A), (1B), (2), (2A), (2B), (3), (3A), or (3B) above), at least about 98% by weight of M^{II} is Ca, and at least about 98% by weight of M^{III} is Al.

The flame retardants of this invention are useful for a wide variety of flame retardant applications. For example they can be effectively utilized in a wide variety of polymers such as thermoplastic and thermosetting polymers and resins and in elastomers (e.g., natural and synthetic rubbers). Preferred uses of the flame retardants of this invention are as components of polyethylene and its copolymers or polypropylene and its copolymers for wire and cable applications or resins like epoxy resins for printed circuit boards. In some of these applications, the improved thermal stability provided by the incorporation of silicate and/or phosphate moieties into the flame retardant is of considerable importance, even though numerically, the number of degrees centigrade (° C.) of enhanced thermal stability relative to comparable conventional materials may appear relatively small. Thus, in the case of forming flame retardant wire and cable compounds, an increase, say, of 3-5° C. can be of considerable importance to the user of the flame retardant because this allows for higher processing temperatures and thus higher throughput, e.g., during extrusion.

As indicated above, a variety of raw materials can be utilized in preparing the flame retardants of this invention. Non-limiting examples of such Group IIA compounds include magnesium bromide, magnesium chloride, magnesium iodide, magnesium hydroxide, magnesium oxide, magnesium nitrate, magnesium phosphate, magnesium sulfate, calcium bromide, calcium chloride, calcium iodide, calcium hydroxide, calcium oxide, calcium nitrate, calcium phosphate, calcium sulfate, strontium bromide, strontium chloride, strontium iodide, strontium hydroxide, strontium oxide, strontium nitrate, strontium phosphate, strontium sulfate, barium bromide, barium chloride, barium iodide, barium hydroxide, barium oxide, barium nitrate, barium phosphate, barium sulfate, or mixtures of any two or more of the foregoing. Thus, the Group IIA raw material(s) used can be one or more than one inorganic salt of a Group IIA metal or mixtures of Group IIA metals, or mixtures of one or more than one inorganic Group IIA metal salt with a minor amount of another Group IIA metal salt, e.g., calcium hydroxide or calcium oxide having therein magnesium hydroxide or oxide. Of these, calcium compounds devoid of halogen are preferred; more preferred are calcium hydroxide and calcium oxide. In preferred embodiments of the present invention, the median particle size, d₅₀, of the starting material is <50 μm, preferably <10 μm, and more preferably <2 μm.

Similarly, a wide variety of Group IIIA compounds can be used as raw materials for the preparation of flame retardants of this invention. Non-limiting examples of such Group IIIA compounds include aluminum hydroxide, boehmite, pseudo boehmite, aluminum oxide, aluminum bromide hexahydrate, aluminum chloride hexahydrate, aluminum iodide hexahydrate, aluminum nitrate and its hydrate, aluminum sulfate and its hydrates, aluminum phosphate, gallium nitrate, gallium oxide, gallium oxychloride, gallium sulfate, gallium trichloride, gallium tribromide, indium trichloride, indium nitrate, indium sulfate, or mixtures of any two or more of the foregoing. Of these, the aluminum compounds devoid of halogen are preferred. In preferred embodiments of the present invention, the median particle size, d₅₀, of the starting material is <50 μm, preferably <30 μm, and more preferably <20 μm.

In some embodiments of the present invention, the starting material is milled by any suitable dry or wet milling process known in the art to obtain the desired particle size distribution. The milling process can be applied to i) only the Group IIA source; ii) only the Group IIIA source; iii) both the Group IIA and Group IIIA source; or iv) a mixture of the Group IIA source and Group IIIA source in the molar ratio desired for synthesis of the inventive product.

The particle size of the product has been observed to be influenced by the particle size of the Group IIA metal salt. In general, larger particle sizes of the Group IIA metal salt lead to larger particle sizes of the product. Also, when agglomerates are present in the Group IIA metal salt, the product often also forms agglomerates. Milling of the Group IIA metal salt is a preferred way to minimize or eliminate agglomeration.

The source of silicon used in the preparation of the flame retardants of this invention can vary. Especially useful is an aqueous silicate solution, as for example, (i) one or more of the solutions of, e.g., NaSiO₃ or Na₂Si₃O₇ such as are commercially-available as “water glass” and/or (ii) amorphous or crystalline silicon dioxide in powder form. The source of phosphorus can be an aqueous phosphate solution, e.g., phosphoric acid, alkali or ammonium phosphate salts such as Na₃PO₄, Na₂HPO₄, NaH₂PO₄, alkali or ammonium diphosphate salts such as Na₄P₂O₇, and/or alkali or ammonium polyphosphate salts; all of these phosphorus compounds and their respective hydrates as solids or in aqueous solution.

It is desirable to initially charge the reactor with at least some of the water that will form the aqueous phase, charge thereto the appropriate proportions of the Group II metal source and the Group III metal source (either separately or as a preformed mixture), and thereafter charge the silicon source and/or phosphorus source, if used. If desired, the silicon source and/or phosphorus source may be added before the Group II metal source and/or the Group III metal source.

The mixture formed from a Group IIIA metal source, a Group IIA metal source, optional source of silicon and/or phosphorus, and an alkali metal hydroxide, should be a substantially uniform mixture. Therefore, the mixture is thoroughly agitated and mixed so that a mixture of substantially uniform makeup is formed. This mixture is typically heated and agitated while at one or more elevated temperatures such as, for example, temperatures in the range of about 50 to about 100° C. The agitation and mixing of the components under these temperature conditions is conducted for a period of time at least sufficient to form a flame retardant product of this invention. Ordinarily, the length of this period of heating is not critical, since it can vary depending upon the temperature used and the extent of the uniformity of the mixture as it is being agitated. Typically, the mixture will be agitated or stirred and mixed while at such elevated temperature(s) for a total period of at least about 10 minutes, and in some cases at least about 30 minutes.

Any suitable reaction temperature or sequence of reaction temperatures yielding an acceptable reaction rate can be used. Typically, the reaction is performed at temperatures in the range of about 50 to about 100° C. It should be noted that this reaction is not a precipitation reaction, but instead is a recrystallization via partially solution where at no time all of either calcium or aluminum is completely dissolved.

The obtained suspension of the flame retardant according to the present invention is then filtered and washed to remove impurities therefrom, thus forming a filter cake. The filter cake is then dried by any method known in the art to dry a filter cake. In some exemplary embodiments the filter cake is dried using spin-flash dryers, other continuously operating flash dryers or cell mills techniques in the production of mineral fillers. In all techniques the filter cake is transferred to the dryer using a, depending on the consistency of the filter cake, suitable feeding equipment, e.g., a screw conveyer, and dispersed with one or more rotors. Hot gas, typically air, is induced to the dryer providing the energy for the fast evaporation of the water included in the filter cake. The hot gas stream carries the fine de-agglomerated particles further downstream. Optionally the gas stream can be led through a classifying device to return coarse particles to the dispersion zone for further processing.

However, in other exemplary embodiments, the filter cake is suspended with water to form a slurry. In another embodiment of the present invention, a dispersing agent is added to the filter cake to form a slurry. Non-limiting examples of dispersing agents include polyacrylates, organic acids, naphthalensulfonate/formaldehyde condensate, fatty-alcohol-polyglycol-ether, polypropylene-ethyleneoxide, polyglycol-ester, polyamine-ethyleneoxide, sodium polyphosphate, sodium tripolyphosphate, and polyvinylalcohol. The slurry is then dried by any method known in the art to dry a slurry. This technique generally involves the atomization of a mineral filler feed through the use of nozzles and/or rotary atomizers. The atomized feed is then contacted with a hot gas, typically air, and the spray dried product is then recovered from the hot gas stream. The contacting of the atomized feed can be conducted in either a counter-current or co-current fashion, and the gas temperature, atomization, contacting, and flow rates of the gas and/or atomized feed can be controlled to produce filler particles having desired product properties.

The recovery of the dried product can be achieved through the use of recovery techniques such as filtration, e.g., using fabric filters, or just allowing the dried particles to fall to collect in the drier where they can be removed, but any suitable recovery technique can be used. In preferred embodiments, the product is recovered from the drier by using particle filters and allowing the product to settle at the bottom of the filter housing, using screw conveyors to recover it from there and subsequently convey it through pipes into a silo by means of compressed air.

The drying conditions are conventional and are readily selected by one having ordinary skill in the art. Generally, these conditions include inlet air temperatures typically between 250 and 650° C. and outlet air temperatures typically between 105 and 150° C.

### Flame Retardant Usage

The flame retardants according to the present invention can be used as a flame retardant in a variety of synthetic resins. Non-limiting examples of thermoplastic resins where the flame retardant according to the present invention find use include polyethylene, polypropylene, ethylene-propylene copolymer, polymers and copolymers of C₂ to C₈ olefins (α-olefin) such as polybutene, poly(4-methylpentene-1) or the like, copolymers of these olefins and diene, ethylene-acrylate copolymer, polystyrene, ABS resin, AAS resin, AS resin, MBS resin, ethylene-vinyl chloride copolymer resin, ethylene-vinyl acetate copolymer resin, ethylene-vinyl chloride-vinyl acetate graft polymer resin, vinylidene chloride, polyvinyl chloride, chlorinated polyethylene, chlorinated polypropylene, vinyl chloride-propylene copolymer, vinyl acetate resin, phenoxy resin, polyacetal, polyamide, polyimide, polycarbonate, polysulfone, polyphenylene oxide, polyphenylene sulfide, polyethylene terephthalate, polybutylene terephthalate, methacrylic resin and the like. Further examples of suitable synthetic resins include natural or synthetic rubbers such as EPDM, butyl rubber, isoprene rubber, SBR, NIR, urethane rubber, polybutadiene rubber, acrylic rubber, silicone rubber, fluoro-elastomer, NBR and chloro-sulfonated polyethylene are also included. Further included are polymeric suspensions (lattices).

Preferably, the synthetic resin is a polyethylene-based resin such as high-density polyethylene, low-density polyethylene, linear low-density polyethylene, ultra low-density polyethylene, EVA (ethylene-vinyl acetate resin), EEA (ethylene-ethyl acrylate resin), EMA (ethylene-methyl acrylate copolymer resin), EAA (ethylene-acrylic acid copolymer resin) and ultra high molecular weight polyethylene; and polymers and copolymers of C₂ to C₈ olefins (a-olefin) such as polybutene and poly(4-methylpentene-1), polyvinyl chloride and rubbers. In a more preferred embodiment, the synthetic resin is a polyethylene-based resin.

Thus, in one embodiment, the present invention relates to a flame retarded polymer formulation comprising at least one synthetic resin, selected from those described above, in some embodiments only one and a flame retarding amount of the flame retardant according to the present invention, and optionally other flame retardants, and finished articles made from the flame retarded polymer formulation, e.g., by extrusion or molding processes.

By a flame retarding amount of the flame retardant according to the present invention, it is generally meant in the range of from about 5 wt % to about 90 wt %, based on the weight of the flame retarded polymer formulation, and more preferably from about 10 wt % to about 60 wt %, on the same basis. In a most preferred embodiment, a flame retarding amount is from about 30 wt % to about 60 wt % of the flame retardant according to the present invention, on the same basis.

In one embodiment of the present invention, other flame retardants or combinations of different other flame retardants can be added to the polymer formulation. Non limiting examples of these additional flame retardants are mineral flame retardants like aluminum hydroxides, magnesium hydroxides, boehmites, layered double hydroxides (LDH), organically modified LDHs, clays, organically modified nano-clays, zinc borates, zinc stannates and zinc hydroxy stannates, brominated flame retardants, phosphorus containing flame retardants, nitrogen containing flame retardants and the like. The combinations of (i) synthetic hydrogarnet, whether unmodified or modified by inclusion of silicate and/or phosphate ions in its crystal structure, and (ii) at least one other mineral flame retardant such as described in this paragraph are typically used in relative amounts such that the (i):(ii) weight ratio is in the range of 99:1 to 1:99, and preferably in the range of 95:5 to 5:95. The total amount of such flame retardant combination used in or with a polymer is an amount that is at least sufficient to flame retard the polymer being used.

The flame retarded polymer formulation can also contain other additives commonly used in the art. Non-limiting examples of other additives that are suitable for use in the flame retarded polymer formulations of the present invention include extrusion aids such as polyethylene waxes, Si-based extrusion aids, fatty acids; coupling agents such as amino-, vinyl- or alkyl silanes or maleic acid grafted polymers; sodium stearate or calcium stearate; organoperoxides; dyes; pigments; fillers; blowing agents; thermal stabilizers; antioxidants; antistatic agents; reinforcing agents; metal scavengers or deactivators; impact modifiers; processing aids; mold release aids, lubricants; anti-blocking agents; other flame retardants; UV stabilizers; plasticizers; flow aids; and the like. The proportions of the other optional additives are conventional and can be varied to suit the needs of any given situation.

The methods of incorporation and addition of the components of the flame-retarded polymer formulation is not critical to the present invention and can be any known in the art so long as the method selected involves substantially uniform mixing. For example, each of the above components, and optional additives if used, can be mixed using a Buss Ko-kneader, internal mixers, Farrel continuous mixers or twin screw extruders or in some cases also single screw extruders or two roll mills. The flame retarded polymer formulation can then be molded or extruded in a subsequent processing step. In some embodiments, apparatuses can be used that thoroughly mix the components to form the flame retarded polymer formulation and also mold an article out of the flame retarded polymer formulation.

In the case of an extruded article, any extrusion technique known to be effective with the synthetic resins mixture described above can be used. In one exemplary technique, the synthetic resin, the flame retardant according to the present invention, and optional components, if chosen, are compounded in a compounding machine to form a flame-retardant resin formulation as described above. The flame-retardant resin formulation is then heated to a molten state in an extruder, and the molten flame-retardant resin formulation is then extruded through a selected die to form an extruded article or to coat for example a metal wire or a glass fiber used for data transmission.

In another embodiment of the present invention, the flame retarded polymer formulation of the present invention also comprises at least one, in some cases more than one, synthetic resin selected from thermosetting resins. Non-limiting examples of thermosetting resins include epoxy resins, novolac resins, phosphorus-containing resins like DOPO, modified epoxy resins such as, for examples, brominated epoxy resins, unsaturated polyester resins and vinyl esters. The flame retarded resin formulation can also contain other additives commonly used in the art. Non-limiting examples of other additives that are suitable for use in the flame retarded polymer formulations of the present invention in addition to those cited above, include solvents, curing agents such as hardeners or accelerators, dispersing agents or fine silica.

In one embodiment of the present invention, other flame retardants or combinations of different other flame retardants can be added to the thermosetting polymer formulation. Non limiting examples of these additional flame retardants are mineral flame retardants like aluminum hydroxides, magnesium hydroxides, boehmites, layered double hydroxides (LDH), organically modified LDHs, clays, organically modified nano-clays, zinc borates, zinc stannates and zinc hydroxy stannates, brominated flame retardants, phosphorus containing flame retardants, nitrogen containing flame retardants and the like. The combinations of (i) synthetic hydrogarnet, whether unmodified or modified by inclusion of silicate and/or phosphate ions in its crystal structure, and (ii) at least one other mineral flame retardant such as described in this paragraph are typically used in relative amounts such that the (i):(ii) weight ratio is in the range of 99:1 to 1:99, and preferably in the range of 95:5 to 5:95. The total amount of such flame retardant combination used in or with a thermosetting polymer formulation is an amount that is at least sufficient to flame retard the thermosetting polymer formulation being used.

The proportions of the other optional additives are conventional and can be varied to suit the needs of any given situation. The preferred method of incorporation and addition of the components of the thermosetting polymer formulation is by high shear mixing. For example, by using a high shear mixer manufactured for example by the Silverson company. Further processing of the resin-filler mix is common state of the art and described in the literature. For example, for cured laminates, further processing of the resin-filler mix to the “prepreg” stage and then to the cured laminate is described in the “Handbook of Epoxide Resins”, published by the McGraw-Hill Book Company, which is incorporated herein in its entirety by reference.

In another embodiment of the present invention, the flame retarded polymer formulation of the present invention also comprises at least one, in some cases more than one, polymer-modified bitumen. Non-limiting examples of polymer-modified bitumens include those modified with polypropylene and those modified with styrene-butadiene-styrene rubber. The flame retarded bitumen formulation can also contain other additives commonly used in the art. Non-limiting examples of other additives that are suitable for use in the flame retarded polymer formulations of the present invention are the other additives described above. In still other embodiments of the present invention, other flame retardants or combinations of different other flame retardants can be added to the polymer-modified bitumen formulation. The proportions of the other optional additives are conventional and can be varied to suit the needs of any given situation.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. For example, a flame retarding amount of the flame retardant according to the present invention, can also include amounts in the range of about 70 to about 90 wt %, 20 to about 65 wt %, etc.

Further embodiments of the invention include, without limitation:

a) A flame retarded polymer formulation comprising at least one synthetic resin or rubber and in the range of from about 5 wt % to about 90 wt % of at least one flame retardant comprised of synthetic hydrogarnet optionally modified by inclusion of silicon atoms and/or phosphorus atoms in its crystal structure, wherein said synthetic hydrogarnet has a cubic crystal shape when not modified by inclusion of silicon atoms and/or phosphorus atoms, and, optionally, at least one other flame retardant additive.

b) A flame retarded polymer formulation as in a) wherein said synthetic resin is selected from thermoplastic resins, thermosetting resins and polymeric suspensions.

c) A flame retarded polymer formulation as in a) wherein said synthetic resin is a polyolefin-based resin.

d) A flame retarded polymer formulation as in a) wherein said synthetic resin is an epoxy-based resin.

e) A flame retarded polymer formulation as in a) wherein said synthetic resin is a polyester-based resin.

f) A flame retarded polymer formulation comprising at least one polymer-modified bitumen and in the range of from about 5 wt % to about 90 wt % of at least one flame retardant comprised of synthetic hydrogarnet optionally modified by inclusion of silicon atoms and/or phosphorus atoms in its crystal structure, wherein said synthetic hydrogarnet has a cubic crystal shape when not modified by inclusion of silicon atoms and/or phosphorus atoms, and, optionally, at least one other flame retardant additive.

g) A flame retarded polymer formulation as in a) or f) wherein said flame retardant additive is selected from aluminum hydroxides, magnesium hydroxides, boehmites, layered double hydroxides, organically modified layered double hydroxides, clays, organically modified nano-clays, zinc borates, zinc stannates and zinc hydroxy stannates, brominated flame retardants, phosphorus containing flame retardants, nitrogen containing flame retardants.

h) A flame retarded polymer formulation as in a) or f) wherein said flame retarded polymer formulation contains at least one additional additive selected from extrusion aids; coupling agents; solvents; curing agents; dyes; pigments; fillers; blowing agents; thermal stabilizers; antioxidants; antistatic agents; reinforcing agents; metal scavengers or deactivators; impact modifiers; processing aids; mold release aids, lubricants; anti-blocking agents; UV stabilizers; plasticizers; and flow aids.

i) A flame retarded polymer formulation as in any of a)-h) wherein said flame retardant has the empirical formula:
(A) M^{II}₃M^{III}₂(OH)₁₂₋₄ₓ(SiO₄)ₓ wherein M^{II} is a Group IIA metal atom, M^{III} is a Group IIIA metal atom, and x is a number in the range of about 0.05 to about 1.5; or
(B) M^{II}₃M^{III}₂O_{y}(OH)_{12-5y}(PO₄)_{y} wherein M^{II} and M^{III} are as defined in (A), an y is a number in the range of about 0.05 to about 1.5; or
(C) M^{II}₃M^{III}₂O_{y}(OH)_{12-5y-4x}(PO₄)_{y}(SiO₄)ₓ wherein M^{II} and M^{III} are as defined in (A), wherein x is as defined in (A), and wherein y is as defined in (B), with the proviso that the sum x+y is in the range of 0.05 to about 1.5; or
(D) M^{II}₃M^{III}₂(OH)₁₂ wherein M^{II} and M^{III} are as defined in (A).

j) A flame retarded polymer formulation as in i) wherein said synthetic composition has the empirical formula of (A).

k) A flame retarded polymer formulation as in i) wherein said synthetic composition has the empirical formula of (B).

l) A flame retarded polymer formulation as in i) wherein said synthetic composition has the empirical formula of (C).

m) A flame retarded polymer formulation as in i) wherein said synthetic composition has the empirical formula of (D).

n) A flame retarded polymer formulation as in any of i)-m) wherein M^{II} is (i) Ca, Sr, or Ba, (ii) a mixture of at least two of Ca, Sr, Ba, or (iii) a mixture of Mg with any one or more of Ca, Sr, Ba in which less than about 50% by weight of this mixture of (iii) is Mg; and wherein M^{III} is (i) Al, or (ii) a mixture of Al and one or more of B, Ga, In, Tl, in which less than about 20% by weight of this mixture of (ii) is one or more of B, Ga, In, Tl.

o) A flame retarded polymer formulation as in n) wherein at least about 98% by weight of M^{II} is Ca, and wherein at least about 98% by weight of M^{III} is Al.

The following Examples are presented for purposes of illustration. They are not intended to limit, and should not be construed as limiting the invention to only the details described therein.

General Procedure

The general procedure used in these Examples for synthesizing the new inorganic modified hydrogarnet flame retardants provided by this invention was as follows: Into a 20-liter vessel equipped with an external heating source and a propeller stirrer, are charged a specified amount of water and an alkali hydroxide. While stirring, the mixture is heated until an appropriate temperature is reached and aluminum trihydrate (ATH), a suitable calcium compound and a suitable silicon compound are then added in an appropriate form and in an appropriate amount, and the time of addition is noted. The resultant mixture is continuously stirred at a specified temperature for a period of 1 to 4 hours. At this point, the mixture is removed from the vessel and allowed to cool to room temperature. The resultant mixture in the form of a slurry is then filtered via a filter press and washed with distilled water until a conductivity of <500 μS of the washing water is reached. The filter cakes are recombined and reslurried in water. The resultant slurry is then dried in a Biichi laboratory spray drier, type B-290, operated at 220° C. inlet temperature and about 80° C. outlet temperature. The rate of water evaporation is approximately one liter per hour.

### Test Methods

The methods used for determining the results and properties of the compositions produced and evaluated in the Examples are as follows:
A) BET surface area was measured according to DIN-66132.
B) Median of particle size distribution (d₅₀) was measured by laser diffraction using a Beckman Coulter LS 13 320 particle size analyzer according to ISO 13320. The following detailed procedure is used: A suitable water-dispersant solution is placed in the Beckman particle size analyzer and a background measurement of that solution is made. Approximately 0.5 g of the sample to be measured is then dispersed in the same water-dispersant solution used in obtaining the background measurement, thus forming a suspension. This suspension is subjected to ultrasonic treatment at 200 W for 2 minutes and then introduced into the apparatus by means of a pipette until the optimal measurement concentration is reached, which is given by the manufacturer. In the application software, the appropriate parameters for the sample, i.e., the refractive index and measurement conditions including the PIDS detectors for the nano range, are chosen. Thereafter, the size distribution data are collected at intervals of 90 seconds and analyzed according to Mie scattering theory. To prepare the water/dispersant solution used in these determinations, it is convenient to initially prepare a concentrate from 500 grams of Calgon® dispersant, available from KMF Laborchemie, and 3 liters of CAL Polysalt, available from BASF. This solution is made up to 10 liters with deionized water. Then, 100 ml of this original 10 liters is taken and in turn diluted further to 10 liters with deionized water, and this final solution is used as the water-dispersant solution described above.
C) Thermogravimetric analysis (TGA) was performed using a Mettler Toledo TGA/SDTA 851e instrument. In this analysis, a 70 μl alumina crucible (initial weight of about 180 mg) with the lid under nitrogen (25 ml per minute) was used. The heating rate used was 1° C. per minute.
D) Flame photometry determination of sodium oxide content was conducted using a flame photometer M 7 DC or M 8 D Propan from Dr. Lange.
E) X-Ray powder diffraction (XRD) is carried out on a Siemens D500 instrument equipped with Bragg-Brentano focusing, applying a copper anode with a nickel filter for monochromatization.
F) Cone calorimetry measurements were made according to ASTM E 1354 at 35 kW/m² on 3 mm thick compression molded plates. The Peak Heat Release Rate (PHRR) such as shown in Table 2 is the maximum value of the heat released during combustion of the sample in the cone calorimeter. Where there is a second peak during combustion of a sample in the cone calorimeter, the value of the Heat Release Rate (HRR) is also measured. A Time To Ignition (TTI) value such as given in Table 2 is the time when the sample ignites due to heat exposure in the cone calorimeter. MARHE is the maximum of the average rate of heat emission.

Examples 1-8, 10, and 11 are illustrative of the new flame retardants of this invention and methods for their preparation. Examples 9 and 12 are presented for comparative purposes.

### EXAMPLE 1

### Inventive

In this Example, the initial charges to the 20-liter vessel were 4 liters of water, followed by 324 g NaOH. This mixture was heated while stirring to 95° C. at a rate of about 15° C. per minute. At reaching the desired temperature, 413 grams of fine precipitated aluminum trihydrate, and then 587 grams of calcium hydroxide, then 93 g of water glass (Na₂Si₃O₇) sodium silicate solution, having a calculated SiO₂ concentration of 27 wt % (available from Riedel-de Haen), were added. This provides a theoretical amount of silicate equivalent to 0.15 mole per mole of synthetic flame retardant, giving the product Ca₃Al₂(OH)_{11.4}(SiO₄)_{0.15}. The mixture was maintained at this temperature, while stirring, for two hours. Results of analytical determinations of this resultant synthetic inorganic modified flame retardant are summarized in Table 1. An SEM picture of the octahedral crystal shapes of this product is shown in FIG. 6. It is to be noted that the “SiO₂” concentration is calculated and is for calculation purposes only. It does not mean there really is SiO₂ present.

### EXAMPLE 2

### Inventive

In this Example, the initial charges to the 20-liter vessel were 4 liters of water, followed by 444 g NaOH. This mixture was heated while stirring to 95° C. at a rate of about 15° C. per minute. At reaching the desired temperature, 413 grams of fine precipitated aluminum trihydrate, and then 587 grams of calcium hydroxide, then 185 g of water glass (Na₂Si₃O₇) sodium silicate solution, having a calculated SiO₂ concentration of 27 wt % (available from Riedel-de Haen), were added. This provides a theoretical amount of silicate equivalent to 0.3 mole per mole of synthetic flame retardant, giving the product Ca₃Al₂(OH)_{10.8}(SiO₄)_{0.3}. The mixture was maintained at this temperature, while stiffing, for two hours. Results of analytical determinations of this resultant synthetic inorganic modified flame retardant are summarized in Table 1.

### EXAMPLE 3

### Inventive

In this Example, the initial charges to the 20-liter vessel were 14.2 liters of water, followed by 3.55 kg Solvay liquor with NaOH conc. of 50 wt. %. This mixture was heated while stiffing to 95° C. at a rate of about 15° C. per minute. At reaching the desired temperature, 1850 grams of fine precipitated aluminum trihydrate, and then 2340 grams of calcium hydroxide, then 750 g of water glass (Na₂Si₃O₇) sodium silicate solution, having a calculated SiO₂ concentration of 27 wt % (available from Riedel-de Haen), were added. This provides a theoretical amount of silicate equivalent to 0.3 mole per mole of synthetic flame retardant, giving the product Ca₃Al₂(OH)_{10.8}(SiO₄)_{0.3}. The mixture was maintained at this temperature, while stiffing, for one hour. Results of analytical determinations of this resultant synthetic inorganic modified flame retardant are summarized in Table 1.

### EXAMPLE 4

### Inventive

In this Example, the initial charges to the 20-liter vessel were 4 liters of water, followed by 705 g NaOH. This mixture was heated while stirring to 95° C. at a rate of about 15° C. per minute. At reaching the desired temperature, 413 grams of fine precipitated aluminum trihydrate, and then 587 grams of calcium hydroxide, then 92 g of phosphoric acid with a concentration of 85 wt % H₃PO₄ were added. This provides a theoretical amount of phosphate equivalent to 0.3 mole per mole of synthetic flame retardant, giving the product Ca₃Al₂O_{0.3}(OH)_{10.5}(PO₄)_{0.3}. The mixture was maintained at this temperature, while stiffing, for two hours. Results of analytical determinations of this resultant synthetic inorganic modified flame retardant are summarized in Table 1.

### EXAMPLE 5

### Inventive

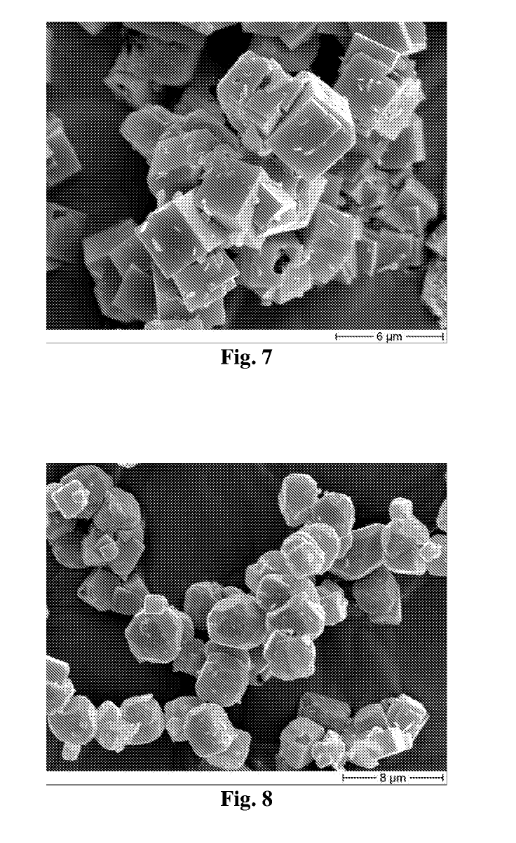

The components charged to the 20-liter vessel were 4 liters of water, 444 g of sodium hydroxide, followed by 413 grams of fine precipitated aluminum trihydrate, and then 587 grams of calcium hydroxide, giving the synthetic hydrogarnet Ca₃Al₂(OH)₁₂. The mixture was then heated during the 2 hour period at 85° C. The pH of the slurry after four hours was 12.1. Results of analytical determinations of this resultant unmodified synthetic calcium aluminate flame retardant are summarized in Table 1. An SEM picture of the cubic crystal shapes of this product is shown in FIG. 7.

TABLE 1

| | | | | | | Martinal OL |
|---|---|---|---|---|---|---|
| | Ex- | Ex- | Ex- | Ex- | Ex- | 104 LEO |
| | ample 1 | ample 2 | ample 3 | ample 4 | ample 5 | (Comparative |
| Product | (Inven- | (Inven- | (Inven- | (Inven- | (Inven- | Flame |
| Properties | tive) | tive) | tive) | tive) | tive) | Retardant) |
| BET, | 1.0 | 1.2 | 0.9 | 4.9 | 1.5 | 4.1 |
| m²/g | | | | | | |
| d₅₀, μm | 3.7 | 3.9 | 4.2 | 5.9 | 3.2 | 2.1 |
| TGA, ° C. | 248 | 266 | 254 | 250 | 240 | 225 |
| for 2% wt | | | | | | |
| loss | | | | | | |
| TGA, ° C. | 264 | 286 | 272 | 280 | 250 | 245 |
| for 5% wt | | | | | | |
| loss | | | | | | |
| TGA, % | 26 | 24 | 25 | 24 | 28 | 34.6 |
| total wt | | | | | | |
| loss | | | | | | |

Table 1 shows that the inventive flame retardant materials have a significantly higher thermal stability than Aluminium Trihydrate (ATH), represented by the commercially available ATH flame retardant Martinal OL-104 LEO produced by Martinswerk GmbH. It further shows the enhanced thermal stability of silicate and phosphate modified hydrogarnet materials (Examples 1-4) when compared to the unmodified hydrogarnet (Example 5).

### EXAMPLE 6

### Inventive

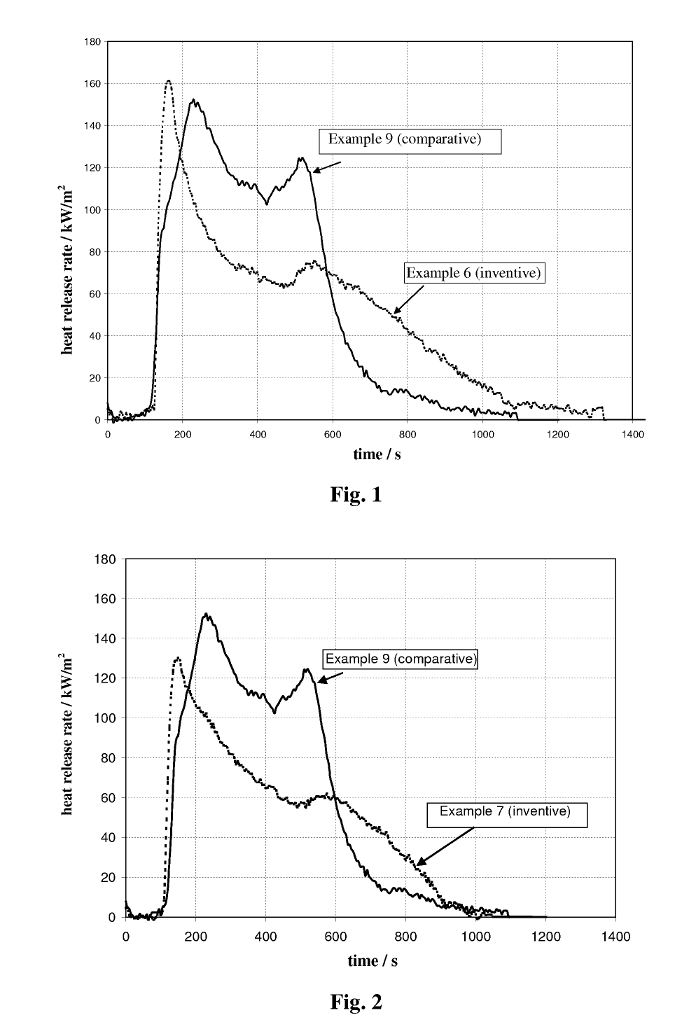

100 phr (about 396.9 g) of ethylene-vinyl acetate copolymer (EVA) Escorene™ Ultra UL00119 from ExxonMobil was mixed for about 20 minutes on a two roll mill W150M from the Collin company with 150 phr (about 595.3 g) of the inventive flame retardant produced in Example 1, together with 1.2 phr (about 4.8 g) of the amino silane AMEO from Evonik and 0.75 phr (about 3.0 g) of pentaerythritol tetrakis(3-(3,5-di-tert-butyl-4-hydroxyphenyl)propionate) (Ethanox® 310 antioxidant from Albemarle Corporation). Mixing on the two roll mill was done in a usual manner familiar to a person skilled in the art. The temperature of the two rolls was set to 130° C. The ready compound was removed from the mill, and after cooling to room temperature, was further reduced in size to obtain granulates suitable for compression molding in a two platen press. FIG. 1 shows the cone calorimeter heat release rate curve, measured at 35 kW/m² on 3 mm thick compression molded plates. Table 2 presents some characteristic values of the cone curve (i.e., PHRR, TTI, MARHE, and the heat release rate (HRR) and the time of the second maximum).

### EXAMPLE 7

### Inventive

100 phr (about 396.9 g) of ethylene-vinyl acetate copolymer (EVA) Escorene™ Ultra UL00119 from ExxonMobil was mixed for about 20 minutes on a two roll mill W150M from the Collin company with 150 phr (about 595.3 g) of the inventive flame retardant produced in Example 2, together with 1.2 phr (about 4.8 g) of the amino silane AMEO from Evonik and 0.75 phr (about 3.0 g) of pentaerythritol tetrakis(3-(3,5-di-tert-butyl-4-hydroxyphenyl)propionate) (Ethanox® 310 antioxidant from Albemarle Corporation). Mixing on the two roll mill was done in a usual manner familiar to a person skilled in the art. The temperature of the two rolls was set to 130° C. The ready compound was removed from the mill, and after cooling to room temperature, was further reduced in size to obtain granulates suitable for compression molding in a two platen press. FIG. 2 shows the cone calorimeter heat release rate curve, measured at 35 kW/m² on 3 mm thick compression molded plates. Table 2 presents some characteristic values of the cone curve (i.e., PHRR, TTI, MARHE, and the heat release rate (HRR) and the time of the second maximum).

### EXAMPLE 8

### Inventive

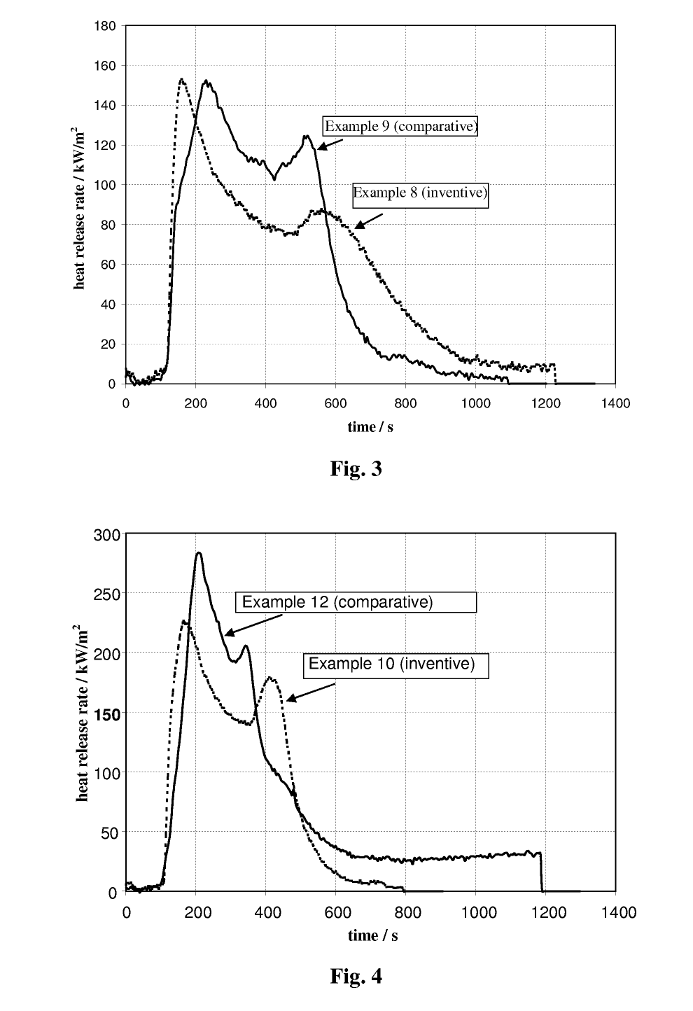

100 phr (about 396.9 g) of ethylene-vinyl acetate copolymer (EVA) Escorene™ Ultra UL00119 from ExxonMobil was mixed for about 20 min on a two roll mill W150M from the Collin company with 150 phr (about 595.3 g) of the comparative additive produced in Example 5, together with 1.2 phr (about 4.8 g) of the amino silane AMEO from Evonik and 0.75 phr (about 3.0 g) of Ethanox® 310 antioxidant from Albemarle Corporation. Mixing on the two roll mill was done in a usual manner familiar to a person skilled in the art. The temperature of the two rolls was set to 130° C. The ready compound was removed from the mill, and after cooling to room temperature, was further reduced in size to obtain granulates suitable for compression molding in a two platen press. FIG. 3 shows the cone calorimeter heat release rate curve, measured at 35 kW/m² on 3 mm thick compression molded plates. Table 2 presents some characteristic values of the cone curve (i.e., PHRR, TTI, MARHE, and the heat release rate (HRR) and time of the second maximum).

### EXAMPLE 9

### Comparative

100 phr (about 396.9 g) of ethylene-vinyl acetate copolymer (EVA) Escorene™ Ultra UL00119 from ExxonMobil was mixed for about 20 min on a two roll mill W150M from the Collin company with 150 phr (about 595.3 g) of the commercial comparative ATH flame retardant Martinal OL-104 LEO produced by Martinswerk GmbH, together with 1.2 phr (about 4.8 g) of the amino silane AMEO from Evonik and 0.75 phr (about 3.0 g) of Ethanox® 310 antioxidant from Albemarle Corporation. Mixing on the two roll mill was done in a usual manner familiar to a person skilled in the art. The temperature of the two rolls was set to 130° C. The ready compound was removed from the mill, and after cooling to room temperature, was further reduced in size to obtain granulates suitable for compression molding in a two platen press. FIGS. 1, 2, and 3 show the cone calorimeter heat release rate curve, measured at 35 kW/m² on 3 mm thick compression molded plates. Table 2 presents some characteristic values of the cone curve (i.e., PHRR, TTI, MARHE, and the heat release rate (HRR) and the time of the second maximum). In Table 2, Examples 6, 7, and 8 are Examples of the present invention, whereas Example 9 is a comparative Example.

TABLE 2

| | Example 6 | Example 7 | Example 8 | Example 9 |
|---|---|---|---|---|
| Cone data | (Inventive) | (Inventive) | (Inventive) | (Comparative) |
| PHRR | 161 | 130 | 153 | 152 |
| (kW/m²) | | | | |
| TTI (s) | 120 | 99 | 105 | 102 |
| MARHE | 68 | 67 | 76 | 92 |
| HRR of | 75 | 60 | 87 | 125 |
| second peak | | | | |
| (kW/m²) | | | | |
| Time to | 560 | 590 | 561 | 520 |
| second | | | | |
| peak (s) | | | | |

It follows from Table 2 that the PHRR of inventive Example 7 is significantly lower than for the comparative Example 9. Although the PHRR of inventive Examples 6 and 8 are, within the experimental error, equal to the PHRR of Example 9, FIGS. 1, 2, and 3 show that the heat release rate of the inventive Examples after the initial peak is significantly lower than for the comparative Example 9, thus indicating a better flame retardant performance. The MARHE also is reduced for the inventive Examples 6, 7, and 8.

The time value corresponding to the second maximum of the cone curve is generally correlated with the char forming potential of a filler: the stronger the char, the longer it will take for this second peak to appear. Table 2 shows that inventive Examples 6, 7, and 8 all show a significantly longer “time to second peak” than the comparative Example 9, which indicates the state of the art for mineral flame retardant fillers. Also, it should be noted that the heat release rate of the second peak is significantly lower for inventive Examples 6, 7, and 8 than for Example 9, both as regards the absolute value as well as the value in relation to the PHRR of the respective Example.

### EXAMPLE 10

### Inventive

67 phr (about 333.8 g) of ethylene-vinyl acetate copolymer (EVA) Escorene™ Ultra UL00328 from ExxonMobil and 17 phr (about 84.7 g) of linear low density polyethylene (LLDPE) LL1001XV from ExxonMobil were mixed for about 20 minutes on a two roll mill W150M from the Collin company with 100 phr (about 498.1 g) of the inventive flame retardant produced in Example 4, together with 8 phr (about 39.9 g) of a random terpolymer of Ethylene (E), Butyl Acrylate (BA) and Maleic Anhydride (MAH) Lotader 3210 from Arkema, 8 phr (about 39.9 g) of MAH grafted LLDPE Fusabond MB 226D of DuPont and 0.75 phr (about 3.7 g) of pentaerythritol tetrakis(3-(3,5-di-tert-butyl-4-hydroxyphenyl)propionate) (Ethanox®310 antioxidant from Albemarle Corporation). Mixing on the two roll mill was done in a usual manner familiar to a person skilled in the art. The temperature of the two rolls was set to 150° C. The ready compound was removed from the mill, and after cooling to room temperature, was further reduced in size to obtain granulates suitable for compression molding in a two platen press. FIG. 4 shows the cone calorimeter heat release rate curve, measured at 35 kW/m² on 3 mm thick compression molded plates. Table 3 presents some characteristic values of the cone curve (i.e., PHRR, TTI, MARHE and the heat release rate (HRR) and the time of the second maximum).

### EXAMPLE 11

### Inventive

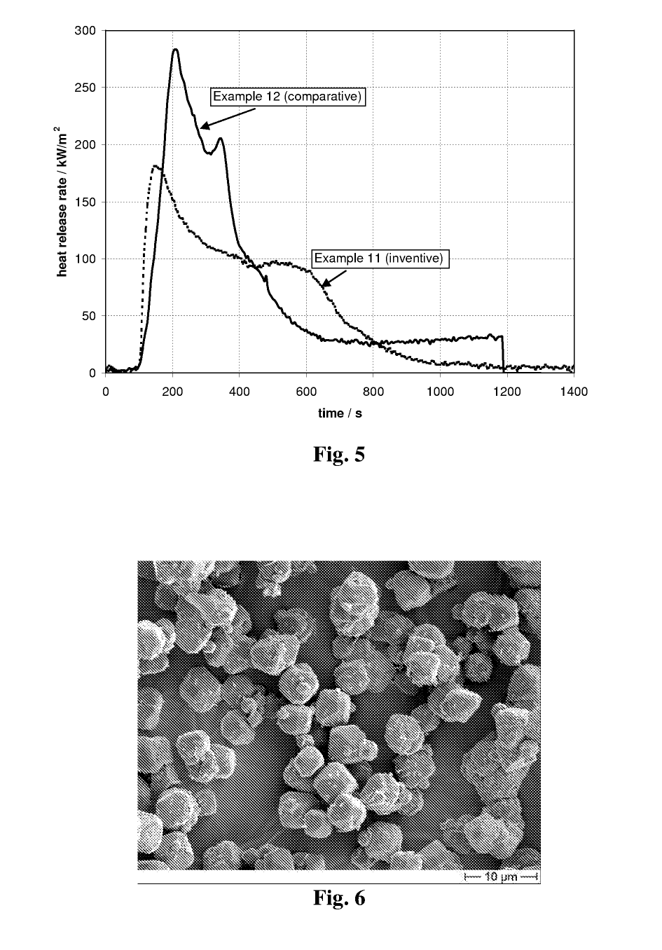

67 phr (about 333.8 g) of ethylene-vinyl acetate copolymer (EVA) Escorene™ Ultra UL00328 from ExxonMobil and 17 phr (about 84.7 g) of linear low density polyethylene (LLDPE) LL1001XV from ExxonMobil were mixed for about 20 minutes on a two roll mill W150M from the Collin company with 100 phr (about 498.1 g) of the inventive flame retardant produced in Example 5, together with 8 phr (about 39.9 g) of a random terpolymer of Ethylene (E), Butyl Acrylate (BA) and Maleic Anhydride (MAH) Lotader 3210 from Arkema, 8 phr (about 39.9 g) of MAH grafted LLDPE Fusabond MB 226D of DuPont and 0.75 phr (about 3.7 g) of pentaerythritol tetrakis(3-(3,5-di-tert-butyl-4-hydroxyphenyl)propionate) (Ethanox® 310 antioxidant from Albemarle Corporation). Mixing on the two roll mill was done in a usual manner familiar to a person skilled in the art. The temperature of the two rolls was set to 150° C. The ready compound was removed from the mill, and after cooling to room temperature, was further reduced in size to obtain granulates suitable for compression molding in a two platen press. FIG. 5 shows the cone calorimeter heat release rate curve, measured at 35 kW/m² on 3 mm thick compression molded plates. Table 3 presents some characteristic values of the cone curve (i.e., PHRR, TTI, MARHE and the heat release rate (HRR) and the time of the second maximum).

### EXAMPLE 12

### Comparative

67 phr (about 333.8 g) of ethylene-vinyl acetate copolymer (EVA) Escorene™ Ultra UL00328 from ExxonMobil and 17 phr (about 84.7 g) of linear low density polyethylene (LLDPE) LL1001XV from ExxonMobil were mixed for about 20 minutes on a two roll mill W150M from the Collin company with 100 phr (about 498.1 g) of the of the commercial comparative ATH flame retardant Martinal OL-104 LEO produced by Martinswerk GmbH, together with 8 phr (about 39.9 g) of a random terpolymer of Ethylene (E), Butyl Acrylate (BA) and Maleic Anhydride (MAH) Lotader 3210 from Arkema, 8 phr (about 39.9 g) of MAH grafted LLDPE Fusabond MB 226D of DuPont and 0.75 phr (about 3.7 g) of pentaerythritol tetrakis(3-(3,5-di-tert-butyl-4-hydroxyphenyl)propionate) (Ethanox®310 antioxidant from Albemarle Corporation). Mixing on the two roll mill was done in a usual manner familiar to a person skilled in the art. The temperature of the two rolls was set to 150° C. The ready compound was removed from the mill, and after cooling to room temperature, was further reduced in size to obtain granulates suitable for compression molding in a two platen press. FIGS. 4 and 5 show the cone calorimeter heat release rate curve, measured at 35 kW/m² on 3 mm thick compression molded plates. Table 3 presents some characteristic values of the cone curve (i.e., PHRR, TTI, MARHE and the heat release rate (HRR) and the time of the second maximum).

TABLE 3

| | Example 10 | Example 11 | Example 12 |
|---|---|---|---|
| Cone data | (Inventive) | (Inventive) | (Comparative) |
| PHRR | 227 | 181 | 283 |
| (kW/m²) | | | |
| TTI (s) | 100 | 91 | 108 |
| MARHE | 128 | 96 | 137 |
| HRR of | 176 | 94 | 201 |
| second peak | | | |
| (kW/m²) | | | |
| Time to | 420 | 545 | 350 |
| second | | | |
| peak (s) | | | |

It should be noted that the polymer formulation for Examples 10-12 is different and the amount of filler is significantly lower; the two formulations cannot be compared to each other.

It follows from Table 3 that the PHRR of inventive Examples 10 and 11 is significantly lower than for the comparative Example 12. FIGS. 4 and 5 show that the heat release rate of the inventive Example after the initial peak is significantly lower than for the comparative Example 11, thus indicating a better flame retardant performance. The MARHE also is reduced for the inventive Example.

The time value corresponding to the second maximum of the cone curve is generally correlated with the char forming potential of a filler: the stronger the char, the longer it will take for this second peak to appear. Table 3 shows that inventive Examples 10 and 11 show a significantly longer “time to second peak” than comparative Example 12. Example 12 indicates the state of the art for mineral flame retardant fillers. Also, it should be noted that the heat release rate of the second peak is significantly lower for inventive Examples 10 and 11 than for comparative Example 12.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

Each and every patent or publication referred to in any portion of this specification is incorporated in toto into this disclosure by reference, as if fully set forth herein.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text taken in context clearly indicates otherwise.

The invention may comprise, consist or consist essentially of the materials and/or procedures recited herein.

This invention is susceptible to considerable variation in its practice. Therefore the foregoing description is not intended to limit, and should not be construed as limiting, the invention to the particular exemplifications presented hereinabove.

1. A flame retardant comprised of synthetic hydrogarnet optionally modified by inclusion of silicon atoms and/or phosphorus atoms in its crystal structure, wherein said synthetic hydrogarnet has a cubic crystal shape when not modified by inclusion of silicon atoms and/or phosphorus atoms.

2. A flame retardant as in claim 1 having the empirical formula:
(A) M^{II}₃M^{III}₂(OH)₁₂₋₄ₓ(SiO₄)ₓ wherein M^{II} is a Group IIA metal atom, M^{III} is a Group IIIA metal atom, and x is a number in the range of about 0.05 to about 1.5; or
(B) M^{II}₃M^{III}₂O_{y}(OH)_{12-5y}(PO₄)_{y} wherein M^{II} and M^{III} are as defined in (A), and y is a number in the range of about 0.05 to about 1.5; or
(C) M^{II}₃M^{III}₂O_{y}(OH)_{12-5y-4x}(PO₄)_{y}(SiO₄)ₓ wherein M^{II} and M^{III} are as defined in (A), wherein x is as defined in (A), and wherein y is as defined in (B), with the proviso that the sum x+y is in the range of about 0.05 to about 1.5; or
(D) M^{II}₃M^{III}₂(OH)₁₂ wherein M^{II} and M^{III} are as defined in (A).

3. A flame retardant as in claim 2 wherein said synthetic hydrogarnet has the empirical formula of (A).

4. A flame retardant as in claim 2 wherein said synthetic hydrogarnet has the empirical formula of (B).

5. A flame retardant as in claim 2 wherein said synthetic hydrogarnet has the empirical formula of (C).

6. A flame retardant as in claim 2 wherein said synthetic hydrogarnet has the empirical formula of (D).

7. A flame retardant as in claim 2 wherein M^{II} is (i) Ca, Sr, or Ba, (ii) a mixture of at least two of Ca, Sr, Ba, or (iii) a mixture of Mg with any one or more of Ca, Sr, Ba in which less than about 50% by weight of this mixture of (iii) is Mg; and wherein M^{III} is (i) Al, or (ii) a mixture of Al and one or more of B, Ga, In, Tl, in which less than about 20% by weight of this mixture of (ii) is one or more of B, Ga, In, Tl.

8. A flame retardant as in claim 7 wherein at least about 98% by weight of M^{II} is Ca, and wherein at least about 98% by weight of M^{III} is Al.

9. A process for forming a compound having the empirical formula
a) M^{II}₃M^{III}₂(OH)₁₂₋₄ₓ(SiO₄)ₓ wherein M^{II} is a Group HA metal atom, M^{III} is a Group IIIA metal atom, and x is a number in the range of about 0.05 to about 1.5,
b) M^{II}₃M^{III}₂O_{y}(OH)_{12-5y}(PO₄)_{y} wherein M^{II} and M^{III} are as defined in a), is a number in the range of about 0.05 to about 1.5, or
c) M^{II}₃M^{III}₂O_{y}(OH)_{12-5y-4x}(PO₄)_{y}(SiO₄)ₓ wherein M^{II} and M^{III} are as defined in a), wherein x is as defined in a), wherein y is as defined in b), with the proviso that the sum x+y is in the range of 0.05 to about 1.5, or
d) M^{II}₃M^{III}₂(OH)₁₂ wherein M^{II} and M^{III} are as defined in a),
which process comprises
i) agitating a mixture formed from (1) a Group IIIA metal source, (2) a Group HA metal source, (3) a source of silicon when forming compounds of formula a) or c), (4) a source of phosphorus when forming compounds of formula b) or c), and (5) an alkali metal hydroxide;
ii) heating said mixture at a temperature in the range of about 50 to about 100° C.; and
iii) optionally cooling the reaction product or allowing the reaction product to cool,
wherein the proportions of said Group IIIA metal source and said Group HA metal source used in forming said mixture are in a molar ratio of Group HA metal:Group IIIA metal in the range of about 1:1 to about 2:1, and wherein said source of silicon used in forming said mixture provides silicate in amounts in the range of about 0.05 to about 1.5 moles of silicate per mole of compound to be formed, and/or wherein said source of phosphorus used in forming said mixture provides phosphate in amounts in the range of about 0.05 to about 1.5 moles of phosphate per mole of compound to be formed.

10. A process as in claim 9 wherein said compound has the empirical formula of a).

11. A process as in claim 9 wherein said compound has the empirical formula of b).

12. A process as in claim 9 wherein said compound has the empirical formula of c).

13. A process as in claim 9 wherein said compound has the empirical formula of d).

14. A process as in claim 9 wherein in said mixture (1) is an aluminum source, and/or (2) is a calcium source, and/or (3) is an aqueous silicate solution or crystalline silicon dioxide, and/or (4) is an aqueous phosphate solution.

15. A process as in claim 14 wherein in said mixture
said aluminum source is aluminum hydroxide, boehmite, pseudo boehmite, aluminum oxide, or mixtures of any two or more of the foregoing, and/or
said calcium source is an inorganic salt, hydroxide, or oxide of calcium, including hydrates thereof, and/or
said aqueous silicate solution is one or more solutions of NaSiO₃ or Na₂Si₃O₇, and/or
said aqueous phosphate solution is one or more solutions of phosphoric acid, an alkali or ammonium phosphate salt, an alkali or ammonium diphosphate salt, and/or an alkali or ammonium polyphosphate salt.

16. A flame retarded polymer formulation comprising at least one synthetic resin or rubber or at least one polymer-modified bitumen, and in the range of from about 5 wt % to about 90 wt % of at least one flame retardant as in claim 1 and, optionally, at least one other flame retardant additive.

17. A flame retarded polymer formulation as in claim 16 wherein said formulation comprises a synthetic resin, and wherein said synthetic resin is selected from thermoplastic resins, thermosetting resins and polymeric suspensions.

18. A flame retarded polymer formulation as in claim 16 wherein said formulation comprises a synthetic resin, and wherein said synthetic resin is a polyolefin-based resin.

19. A flame retarded polymer formulation as in claim 16 wherein said formulation comprises a synthetic resin, and wherein said synthetic resin is an epoxy-based resin.

20. A flame retarded polymer formulation as in claim 16 wherein said formulation comprises a synthetic resin, and wherein said synthetic resin is a polyester-based resin.

21. A flame retarded polymer formulation as in claim 16 wherein said flame retardant additive is selected from aluminum hydroxides, magnesium hydroxides, boehmites, layered double hydroxides, organically modified layered double hydroxides, clays, organically modified nano-clays, zinc borates, zinc stannates and zinc hydroxy stannates, brominated flame retardants, phosphorus containing flame retardants, nitrogen containing flame retardants.

22. A flame retarded polymer formulation as in claim 16 wherein said flame retarded polymer formulation contains at least one additional additive selected from extrusion aids; coupling agents; solvents; curing agents; dyes; pigments; fillers; blowing agents; thermal stabilizers; antioxidants; antistatic agents; reinforcing agents; metal scavengers or deactivators; impact modifiers; processing aids; mold release aids, lubricants; anti-blocking agents; UV stabilizers; plasticizers; and flow aids.
